(19) United States
(12) Patent Application Publication
(10) Pub. No.: US 2025/0274476 A1
(43) Pub. Date: Aug. 28, 2025

(54) MACHINE LEARNING TECHNIQUES FOR ANALYZING OPERATIONAL TECHNOLOGY NETWORKS

(71) Applicant: Frenos Inc., Charlotte, NC (US)

(72) Inventors: Harry Thomas, Charlotte, NC (US); Brian Proctor, Carlsbad, CA (US)

(73) Assignee: Frenos Inc., Charlotte, NC (US)

(21) Appl. No.: 19/067,228

(22) Filed: Feb. 28, 2025

Related U.S. Application Data
(60) Provisional application No. 63/559,095, filed on Feb. 28, 2024.

(51) Int. Cl. H04L 9/40

(52) U.S. Cl. CPC H04L 63/1433

(57) ABSTRACT

Machine learning techniques are provided for analyzing operational technology networks. An attack simulation model is trained to simulate attacks on a network replica by a plurality of threats. The attack simulation model outputs simulated attack data comprising a set of simulated attack paths corresponding to one or more threats of the plurality of threats. The network replica comprises a structured representation of a plurality of assets belonging to an OT network environment, communication pathways between the plurality of assets, security controls implemented in the OT network environment, and vulnerabilities. A threat analysis system is generated. The threat analysis system is configured to apply the attack simulation model to an input network replica and provide one or more risk reduction recommendations based on output simulated attack data from the attack simulation model. The threat analysis system is deployed to generate risk reduction recommendations for one or more OT network environments.

### CROSS-REFERENCE TO RELATED APPLICATIONS; BENEFIT CLAIM

This application claims the benefit of U.S. Provisional Application No. 63/559,095, filed Feb. 28, 2024, the entire contents of which are hereby incorporated by reference as if fully set forth herein, under 35 U.S.C. § 119(e).

### FIELD OF THE DISCLOSURE

The present disclosure generally relates to machine learning techniques, and relates more specifically to models for attack simulation and analysis.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely based on their inclusion in this section.

Operational technology (OT) refers to hardware and/or software systems designed to monitor and control physical processes, devices, and infrastructure. This includes industrial control systems, which are deployed to manage industrial operations across sectors such as oil, gas, manufacturing, pharmaceuticals, building automation, mining, electricity generation, electricity distribution, water treatment, other utilities, transportation, and more. As OT networks become larger and more connected, their exposure to vulnerabilities increases. Security threats to OT network environments can lead to significant disruptions, potentially causing damage to critical equipment and infrastructure and resulting in costly remediation efforts.

Within cybersecurity, it is difficult to assess the vulnerability of a company's network, also referred to as risk exposure. It can take months to accurately assess a company's risk exposure correctly. Furthermore, such assessments only provide a snapshot at of risk a historical point in time. Even small changes to the company's network can potentially alter the risk assessment, limiting the utility of point-in-time assessments. Furthermore, traditional vulnerability assessment techniques, such as penetration testing and other live network testing, pose significant risks in OT network environments. Industrial control systems are highly sensitive and critical, and successfully exploiting a vulnerability could result in severe consequences, such as disrupting the water or power supply.

### SUMMARY

The appended claims may serve as a summary.

### BRIEF DESCRIPTION OF THE DRAWINGS

In the drawings:

FIG. 1 illustrates a computer system that includes a threat analysis system in an example embodiment.

FIG. 2 illustrates data flow between components of a threat analysis system in accordance with one or more embodiments.

FIG. 3 illustrates a computer system that includes an on-premises threat analysis system in an OT network in accordance with one or more embodiments.

FIG. 4 illustrates a portion of a graph database of a network replica to depict a schema in accordance with one or more embodiments.

FIG. 5 is a flow diagram of a process for training and using an attack simulation model in an example embodiment.

FIG. 6 is a block diagram illustrating an example computer system upon which an embodiment may be implemented.

While each drawing figure illustrates a particular embodiment for the purpose of providing a clear example, other embodiments may omit, add to, reorder, or modify any of the elements shown in the drawing figures. Unless otherwise specified, aspects disclosed with respect to an embodiment of an element in a figure may optionally be applied to another embodiment of the element in another figure. For purposes of illustrating clear examples, one or more figures may be described with reference to one or more other figures. However, using the particular arrangement illustrated in such other figure/s is not required in other embodiments.

### DETAILED DESCRIPTION

In the following description, numerous specific details are set forth in order to provide a thorough understanding of the subject matter of the present application. It will be apparent, however, to a person of ordinary skill that embodiments may be practiced without incorporating all aspects of the specific details described herein. The detailed description that follows describes exemplary embodiments and the features disclosed are not intended to be limited to the expressly disclosed combination(s). Therefore, unless otherwise noted, features disclosed herein may be combined to form additional combinations that were not otherwise shown for purposes of brevity.

It will be further understood that: the term “or” may be inclusive or exclusive unless expressly stated otherwise; the term “set” may comprise zero, one, or two or more elements; the terms “first”, “second”, “certain”, and “particular” are used as naming conventions to distinguish elements from each other, and does not imply an ordering, timing, or any other characteristic of the referenced items unless otherwise specified; the term “and/or” as used herein refers to and encompasses any and all possible combinations of one or more of the associated listed items; that the terms “includes”, “including”, “comprises”, and/or “comprising” specify the presence of stated features but do not preclude the presence or addition of one or more other features. Unless otherwise specified: “such as” is intended to mean “such as but not limited to”; and examples are intended to be nonlimiting.

As used herein, the term “component” refers to any element, module, device, part, hardware, software, firmware, or any combination thereof. Alternatively and/or additionally, a component may comprise specialized circuitry and/or or mechanical assemblies designed to perform specific functions. A component may be a standalone component, work in conjunction with one or more other components, contain one or more other components, and/or belong to one or more other components. A component may perform specific functions, interact with other components, provide structure, and/or achieve certain operations.

As used herein, the terms “coupled” refers to a connection between two components, which may be direct or indirect, permitting additional intermediary components, elements, structures, or mechanisms between the coupled components. Such connections may encompass, but are not limited to, communicative connections (e.g., electronic, optical, wireless, and/or other communication pathways), mechanical connections, electromagnetic connections, and/or any other form of functional, operative, or interactive association.

As used herein, the term “system” refers to mechanical components, hardware, and/or software stored in, or coupled with, a memory and/or one or more processors on one or more computers. Alternatively and/or additionally, a component may comprise specialized circuitry and/or or mechanical assemblies designed to perform specific functions. A system may be a standalone component, work in conjunction with one or more other systems, contain one or more other systems, and/or belong to one or more other systems. A system may be a computer system, mechanical system, or an integrated system that combines both mechanical and computational elements.

As used herein, the term “computer” refers to any apparatus, electronic device, or system capable of processing data, executing instructions, and/or performing calculations. A computer may include one or more controllers, processors, memory, input/output interfaces, storage devices, and/or any combination thereof. The term encompasses both virtual computers and/or hardware computers, including desktop computers, laptop computers, server computers, edge devices, cloud-based systems, embedded systems, controllers, microcontrollers, and other programmable devices. It applies to standalone and/or networked devices and may include software, firmware, and/or hardware for computational functions.

As used herein, the term “computer system” refers to one or more computers, such as one or more hardware computers, virtual computers, and/or computing devices. For example, a computer system may be, or may include, one or more server computers, desktop computers, laptop computers, mobile devices, special-purpose computing devices with a processor, cloud-based computers, cloud-based clusters of computers, virtual machine instances, and/or other computing devices. A computer system may include another computer system, and a computing device may belong to two or more computer systems. Any reference to a “computer system” may mean one or more computers, unless expressly stated otherwise. When a computer system performs an action, the action is performed by one or more computers of the computer system.

As used herein, the term “device” refers to a mechanical system, a computer system, hardware, and/or software stored in, or coupled with, a memory and/or one or more processors on one or more computers. Alternatively and/or additionally, a device may comprise specialized circuitry and/or or mechanical assemblies designed to perform specific functions. A device may be a standalone device, work in conjunction with one or more other devices, contain one or more other devices, and/or belong to one or more other devices.

A “client” refers to a combination of integrated software components and an allocation of computational resources, such as memory, a computing device, and/or processes on a computing device for executing the integrated software components. The combination of the software and the computational resources is configured to interact with one or more servers over a network, such as the Internet. A client may refer to either the combination of components on one or more computers, or the one or more computers (also referred to as “client computing devices”).

A “server” refers to a combination of integrated software components and an allocation of computational resources, such as memory, a computing device, and/or processes on the computing device for executing the integrated software components. The combination of the software and the computational resources is dedicated to providing a particular type of function on behalf of clients of the server. A server may refer to either the one or more computing devices (also referred to as a “server system”) or the combination of components on one or more computing devices. A server system may include multiple servers; that is, a server system may include a first computing device and a second computing device, which may provide the same or different functionality to the same or different set of clients.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage objects, such as CD or DVD objects, flash memory (such as carried on smartphones, multifunctional devices and/or tablets), and magnetic memory. Computers, terminals, network-enabled devices (e.g., mobile devices, such as cell phones) are all examples of machines and devices that utilize processors, memory, and instructions stored on computer-readable mediums. Additionally, embodiments may be implemented in the form of computer programs, or a computer-usable carrier medium capable of carrying such a program.

General Overview

This document generally describes systems, methods, devices, and machine learning techniques for analyzing operational technology (OT) networks. An attack simulation model is trained to simulate attacks on a network replica by a plurality of threats in a threat database. The threat database includes threat data describing threats capable of compromising OT network environments. The attack simulation model outputs simulated attack data comprising a set of simulated attack paths corresponding to one or more threats of the plurality of threats. The attack simulation model may be configured to simulate a plurality of attack paths through the network replica simultaneously. The attack simulation model may be trained in accordance with machine learning techniques, such as reinforcement learning, neural networks, linear regression, and decision-making processes such as Monte Carlo Tree Search (MCTS) and/or other methods for optimization, prediction, and dynamic decision-making.

In some embodiments, a threat analysis system is generated. The threat analysis system is configured to apply the attack simulation model to an input network replica of an OT network environment and provide one or more risk reduction recommendations based on output simulated attack data from the attack simulation model. In some embodiments, the threat analysis system applies an attack analysis language model to the simulated attack data to generate the one or more risk reduction recommendations. In some embodiments, the attack analysis language model is based on a retentive network.

One aspect of the disclosure is directed to a method comprising: maintaining a threat database comprising threat data describing threats capable of compromising OT network environments; training an attack simulation model to simulate attacks on a network replica by a plurality of threats described in the threat database, the attack simulation model outputting simulated attack data comprising a set of simulated attack paths corresponding to one or more threats of the plurality of threats, the network replica comprising a structured representation of a plurality of assets belonging to an OT network environment, communication pathways between the plurality of assets, security controls implemented in the OT network environment, and vulnerabilities; generating a threat analysis system configured to apply the attack simulation model to an input network replica and provide one or more risk reduction recommendations based on output simulated attack data from the attack simulation model; and deploying the threat analysis system to generate risk reduction recommendations for one or more OT network environments; wherein the method is performed by one or more processors.

In some examples, the attack simulation model is a reinforcement learning model comprising: a representation network configured to encode the current state of the network replica into a latent space representation; a dynamics network configured to predict a future state in an attack sequence given a simulated action; a prediction network configured to estimate a likelihood of success for simulated attack paths; and a value function that optimizes attack path selection.

In some examples, the attack simulation model comprises a neural network, wherein at least a portion of the neural network includes a linear regression model.

In some examples, the attack simulation model is configured to utilize a Monte Carlo Tree Search (MCTS) decision process.

In some examples, the network replica comprises a graph database that includes the structured representation of substantially all connected assets in the OT network environment. Alternatively and/or additionally, the attack simulation model is configured to simulate a plurality of attack paths through the graph database simultaneously.

In some examples, the threat analysis system is configured to apply an attack analysis language model to the simulated attack data to generate the one or more risk reduction recommendations. Alternatively and/or additionally, the attack analysis language model is based on a retentive network. Alternatively and/or additionally, the method includes training the attack analysis language model.

In some examples, deploying the threat analysis system includes providing computer-readable instructions for execution on one or more computing devices in a customer OT network environment.

One aspect of the disclosure is directed to a computer system comprising: one or more hardware processors; at least one memory storing one or more instructions which, when executed by the one or more hardware processors, cause the one or more hardware processors to: maintain a threat database comprising threat data describing threats capable of compromising OT network environments; train an attack simulation model to simulate attacks on a network replica by a plurality of threats described in the threat database, the attack simulation model outputting simulated attack data comprising a set of simulated attack paths corresponding to one or more threats of the plurality of threats, the network replica comprising a structured representation of a plurality of assets belonging to an OT network environment, communication pathways between the plurality of assets, security controls implemented in the OT network environment, and vulnerabilities; generate a threat analysis system configured to apply the attack simulation model to an input network replica and provide one or more risk reduction recommendations based on output simulated attack data from the attack simulation model; and deploy the threat analysis system to generate risk reduction recommendations for one or more OT network environments.

In some examples, the attack simulation model is a reinforcement learning model comprising: a representation network configured to encode the current state of the network replica into a latent space representation; a dynamics network configured to predict a future state in an attack sequence given a simulated action; a prediction network configured to estimate a likelihood of success for simulated attack paths; and a value function that optimizes attack path selection.

In some examples, the attack simulation model comprises a neural network, wherein at least a portion of the neural network includes a linear regression model.

In some examples, the attack simulation model is configured to utilize a Monte Carlo Tree Search (MCTS) decision process.

In some examples, the network replica comprises a graph database that includes the structured representation of substantially all connected assets in the OT network environment. Alternatively and/or additionally, the attack simulation model is configured to simulate a plurality of attack paths through the graph database simultaneously.

In some examples, the threat analysis system is configured to apply an attack analysis language model to the simulated attack data to generate the one or more risk reduction recommendations. Alternatively and/or additionally, the attack analysis language model is based on a retentive network. Alternatively and/or additionally, the method includes training the attack analysis language model.

In some examples, deploying the threat analysis system includes providing computer-readable instructions for execution on one or more computing devices in a customer OT network environment.

In some implementations, the various techniques described herein may achieve one or more of the following advantages: OT network security is enhanced; vulnerabilities are identified in production OT network environments; risk assessment of a production OT network environment may be performed in real time without interruption of the production OT network environment; vulnerabilities may be dynamically detected based on changes to a production OT network environment; real-time vulnerability assessment enables timely mitigation strategies; critical infrastructure, including industrial control systems (ICS) for manufacturing, utilities, and oil and gas systems, are more effectively protected, ensuring the availability and security of essential services; attacks may be simulated on a production OT network environment without putting the production OT network environment at risk; network replicas are generated that enable simultaneous attack modelling of multiple threats; simulated attack data generated by a machine learning model may be translated to actionable recommendations; the techniques may be implemented in a scalable manner to effectively model large OT network environments; analysis may be securely performed within an isolated OT network environment to ensure security, privacy, and/or regulatory requirements. Additional features and advantages are apparent from the specification and the drawings.

### System Overview

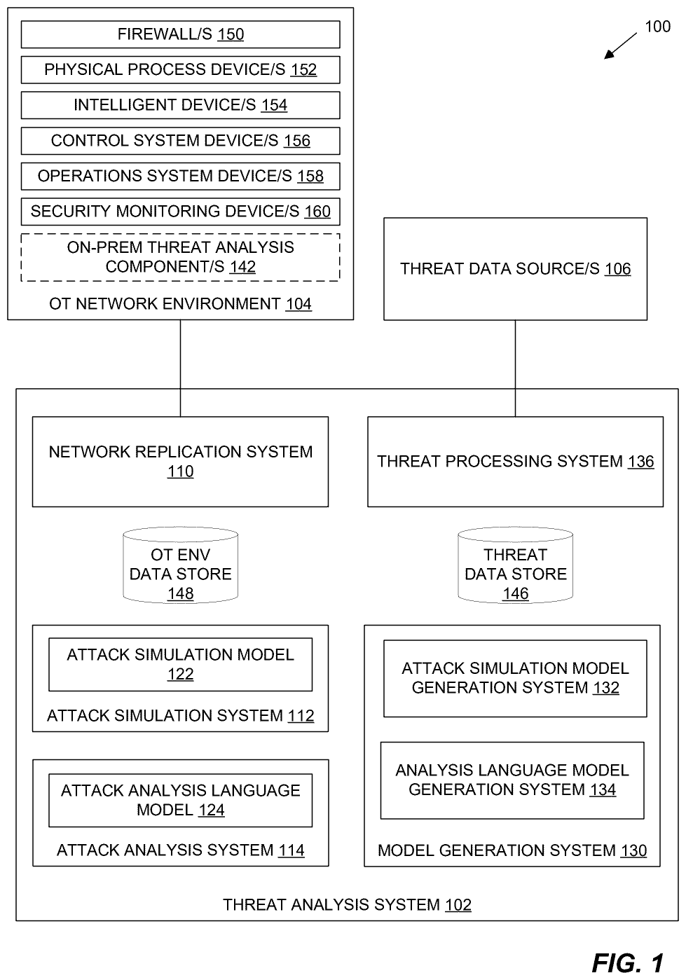

FIG. 1 illustrates a computer system that includes a threat analysis system in an example embodiment. The computer system 100 includes a threat analysis system 102, an OT network environment 104, and one or more threat data sources 106. In some embodiments, the threat analysis system 102 includes a network replication system 110, a threat processing system 136, an attack simulation system 112, an attack analysis system 114, and a model generation system 130. The threat analysis system 102 and/or its components (e.g., network replication system 110, threat processing system 136, attack simulation system 112, attack analysis system 114, and/or model generation system 130) are presented herein as individual components for ease of explanation. Any action performed by or to one or more components of the threat analysis system 102 may be considered performed by or to the threat analysis system 102. The threat analysis system 102 and/or its components may be implemented as one or more dependent or independent processes, and may be implemented on one or multiple computers. For example, a component may be implemented fully and/or partially in one or multiple programs and/or processes, and two or more components shown may be implemented fully and/or partially in the same program and/or process. Alternatively and/or additionally, a component may be implemented as a distributed system. Alternatively and/or additionally, multiple instances of one or more components may be implemented. Alternatively and/or additionally, one or more components may be implemented as a cloud service and/or using one or more cloud service providers.

In some embodiments, one or more components of FIG. 1 communicate over one or more networks. The network/s may include one or more local area networks (LANs) and/or one or more wide area networks, such as the Internet. The network arrangement and/or connectivity between the threat analysis system 102, an OT network environment 104 comprising one or more OT networks, and one or more threat data sources 106 may vary. For example, one or more components of the threat analysis system 102 may be deployed within an OT network environment 104 as one or more on-premises threat analysis components 142, as described in greater detail hereinafter.

An operational technology (OT) network is a network that interconnects systems and devices configured to monitor, control, and manage physical processes, such as in industrial, utility, or critical infrastructure environments. An OT network may support OT-specific protocols, such as Modbus, DNP3, Profibus, OPC-UA, BACnet, and/or other protocols that are tailored to the unique requirements of industrial control systems. OT networks often prioritize low latency and high reliability, such as for safety and continuity. OT networks are typically segregated and/or isolated to protect against cybersecurity risks. While one or more embodiments are described with respect to OT networks and/or OT network environments, the techniques described herein may be adapted to information technology (IT) networks and/or IT network environments, as well as hybrid networks and/or hybrid network environments, without departing from the spirit or scope of the disclosure.

An entity, such as a company, agency, organization, or other entity, may operate an OT network environment 104. For example, an entity may operate an OT network environment 104 comprising multiple OT networks that are segmented into different subnets to control the flow of traffic for better protection. Network segmentation limits an attacker's ability to move through the network. Network segmentation may be achieved through various techniques known in the art, such as air gapping, firewalls, virtual LANs (VLANs), zoning, and/or other techniques. As another example, an entity may operate an OT network environment 104 comprising OT networks at multiple locations, such as remote locations or field locations where automation of industrial systems is implemented.

In some embodiments, the OT network environment 104 includes one or more physical process devices 152. The physical process device/s 152 include one or more instruments or other physical components directly involved in carrying out an industrial process. For example, the physical process device/s 152 may include one or more sensors, actuators, and/or other physical process devices. A sensor is a component that converts a physical phenomenon into a digital and/or analog signal, such as to detect and/or monitor changes in an environment. Examples of sensors include temperature sensors, humidity sensors, pressure sensors, light sensors, flow sensors, touch sensors, proximity sensors, location sensors, accelerometers, gyroscopes, gas sensors, infrared sensors, and/or any other device that can acquire data in the environment in which the device is deployed. An actuator is a component that is responsible for moving and/or controlling a physical mechanism in the environment in which the actuator is deployed. An actuator may act in response to control signals transmitted from another device in the OT network environment 104. Examples of actuators include switches, valves, motors, piezo generators, and/or any other device that controls a physical mechanism.

In some embodiments, the OT network environment 104 includes one or more intelligent devices 154. An intelligent device 154 includes one or more microcontrollers or other processors that are configured to receive data from and/or send control commands to one or more physical process devices 152. An intelligent device 154 may be directly connected to one or more physical process devices 152. For example, the intelligent device/s 154 may include one or more programmable logic controllers (PLCs), remote terminal units (RTUs), intelligent electronic devices (IEDs), and/or other intelligent devices.

In some embodiments, the OT network environment 104 includes one or more control system devices 156. A control system device 156 communicates with lower-level control devices, such as intelligent devices 154, to monitor and control processes and operations in one or more OT networks of the OT network environment 104. For example, the control system device/s 156 may include one or more supervisory control and data acquisition (SCADA) systems, human-machine interfaces (HMIs), master terminal units (MTUs), alarm and alert systems, control room workstations, and/or other control system devices.

In some embodiments, the OT network environment 104 includes one or more operations system devices 158. An operations system device 158 supports site operations within the OT network environment 104. An operations system device 158 may handle communications from the OT network environment 104 to a device in another network. Examples of operations system devices 158 include database servers, application servers, file servers, reliability assurance systems, scheduling and reporting systems, engineering workstations, and the like. The operations system device/s 158 may include at least one historian device configured to aggregate and record production and process data from various sources in the OT network environment 104.

The OT network environment 104 may include one or more OT networks that are isolated from the Internet and/or one or more IT network/s operated by the entity. For example, one or more firewalls 150 may be positioned at the perimeter of an OT network. A firewall 150 is a network security device that monitors incoming and outgoing network traffic. The firewall 150 may permit and/or block data packets based on a set of security rules. The firewall 150 may protect an OT network from unwanted network traffic, such as malicious code, intrusion attempts, and/or other unwanted traffic. In some embodiments, an OT network environment 104 may include a demilitarized zone (DMZ). A DMZ is a sub-network placed between two networks with different trust levels, such as an entity's OT network and the entity's IT network, to add an additional layer of security. A DMZ may be implemented using firewalls, proxy servers, intrusion detection systems (IDSs), intrusion prevention systems (IPSs), and/or other systems. For example, a first firewall 150 may be positioned between the DMZ and an OT network, and a second firewall 150 may be positioned between the DMZ and external networks, such as the entity's IT network and the Internet. Systems typically deployed in the DMZ include proxy servers and the like.

In some embodiments, the OT network environment 104 includes one or more security monitoring devices 160. A security monitoring device 160 may be configured to collect and/or process network traffic in the OT network environment 104. A security monitoring device 160 may be provided by and/or operated by a third-party vendor. A security monitoring device 160 may collect and/or process network traffic to generate telemetry data usable to monitor the OT network environment 104 for security issues. Alternatively and/or additionally, a security monitoring device 160 may perform deep packet inspection. Alternatively and/or additionally, a security monitoring device 160 may analyze such telemetry data. A security monitoring device 160 may be connected to equipment in an OT network environment 104 that provides the security monitoring device 160 access to network traffic, such as a switch, a switched port analyzer (SPAN) port, a network tap, and/or other equipment. In some embodiments, one or more security monitoring devices 160 are deployed in OT network environment 104 as operations system devices 158.

### Network Replication System

In some embodiments, the threat analysis system 102 includes a network replication system 110. The network replication system 110 is configured to generate a network replica of the OT network environment 104. The network replica includes data describing the OT network environment 104. In some embodiments, the network replica includes a structured representation of the plurality of assets belonging to the OT network environment 104 and communication pathways between the plurality of assets. Alternatively and/or additionally, the network replica may include security controls implemented in the OT network environment. Alternatively and/or additionally, the network replica may include vulnerabilities of one or more components of the OT network environment 104. Alternatively and/or additionally, the network replica may include other data, such as access control policies, and/or any other data describing the OT network environment 104 and/or assets connected to the OT network environment 104.

Security controls may include any mechanism, procedure, and/or policy implemented to protect the OT network environment 104 and its assets from threats. Security controls may be implemented as hardware, software, and/or process-based measures. Hardware security controls include dedicated physical devices such as firewalls 150, intrusion detection/prevention systems (IDS/IPS), secure routers, and physical access control systems. Software security controls encompass antivirus programs, encryption tools, patch management systems, and endpoint protection solutions. Additionally, security controls may include hardware configurations, software configurations, and/or administrative controls such as access policies, incident response plans, employee training, and risk management procedures.

Vulnerabilities may include known weaknesses in assets, network equipment, security controls, and other components of the OT network environment 104 that can be exploited by a threat. Vulnerabilities may arise from design defects, firmware issues, software issues, configuration errors, outdated software, insufficient security measures, and other issues. Example vulnerabilities include a default password on a device, a misconfigured firewall rule that allows unauthorized access, and an unpatched software flaw that enables remote code execution.

In some embodiments, the OT network environment 104 is a production OT network environment that is deployed to actively monitor and control physical processes, devices, and/or other operations. Alternatively and/or additionally, the OT network environment 104 may be a live network environment, including production environments, testing environments and/or staging environments. The OT environment data may include data collected from the production OT network environment 104 without requiring any downtime or other disruption to ongoing operations in the production OT network environment 104. The network replication system 110 may use the OT environment data from the production OT network environment 104 to generate a network replica that accurately represents the production OT network environment 104.

The network replication system 110 may continuously capture, analyze, and/or otherwise process OT environment data for the OT network environment 104 in real time. In some embodiments, the network replication system 110 detects changes to the OT network environment 104 based on new OT environment data and updates the network replica based on the detected changes. The threat analysis system 102 may periodically simulate an attack on the current network replica, such as at regular intervals, based on a schedule, and/or in response to detecting a change.

### OT Environment Data Sources

In some embodiments, the network replication system 110 is configured to receive OT environment data. The network replication system 110 may generate the network replica based on the OT environment data.

In some embodiments, the OT environment data may include network data. The network replication system 110 may generate the network replica based on the network data. The network data may be obtained and/or otherwise received from network equipment, such as routers, firewalls, switches, and the like. The network data may include subnet data, routing rules, firewall configuration data, networking device configuration data, and/or other network data. Alternatively and/or additionally, the network data may include NetFlow data describing flow-level network traffic data including source and destination IP addresses, port numbers, protocols, packet counts, data volumes, and the like. In some embodiments, the network replication system 110 includes a structured representation of communication paths in the OT network environment 104 based on the network data.

Alternatively and/or additionally, the OT environment data may include asset data. The network replication system 110 may generate the network replica based on the asset data. The asset data describes one or more assets of the OT network environment 104, such as hostname, IP address, firmware version, software version, configuration data, MAC address, device type, and other data describing the asset. An asset is a device that is connected to one or more OT networks of the OT network environment 104. For example, an asset may include one or more computers, laptops, servers, networking devices, firewalls 150, physical process devices 152, intelligent devices 154, control system devices 156, operations system devices 158, security monitoring devices 160, or any other device that may be connected to an OT network. An asset may be an IP-routable device or a non-IP-enabled device. In some embodiments, the network replica includes a representation of substantially all assets belonging to the OT network environment 104.

Alternatively and/or additionally, the OT environment data may include business data. The network replication system 110 may generate the network replica based on the business data. The business data may include any data that an entity operating the OT network environment 104 generates in the course of operating a business supported by the OT network environment 104. For example, business data may include customer bills comprising utility usage information, inventory records, maintenance logs, production performance metrics, operational performance reports, vendor contracts, supply chain agreements, and service level agreements (SLAs), and/or other business data.

Alternatively and/or additionally, the OT environment data may include security data generated by one or more OT security vendors. The network replication system 110 may generate the network replica based on the security data. For example, the security data may be generated by one or more security monitoring devices 160, which may also be treated as network data. Alternatively and/or additionally, the security data may be generated by one or more OT security vendors that process OT environment data. In some embodiments, security data is obtained and/or otherwise received from one or more OT security vendors that implement Network Security Monitoring (NSM) technology to continuously capture, analyze, and store network data in real time for the purpose of detecting and responding to security threats. The security data may include NSM analysis data generated by one or more OT security vendors.

Alternatively and/or additionally, the OT environment data may include access control data. The network replication system 110 may generate the network replica based on the access control data. The access control data describes policies, user roles, and/or permissions that govern who can access and modify resources within the OT network environment, including assets and configurations. In some embodiments, access control data is obtained and/or otherwise received from Microsoft Active Directory. In some embodiments, the network replica includes a structured representation of access control data. When attack simulation is performed on a network replica comprising access control data, the simulated attack paths may indicate users, groups, and/or accounts that must be successfully compromised for various attack paths to advance successfully.

In some embodiments, the network replication system 110 is configured to enhance the network replica based on one or more outside data sources. For example, the network replication system 110 may maintain asset information from one or more manufacturers of OT network components in an asset data store. The network replication system 110 may add relevant information to the network replica based on determining that particular asset information in the asset data store is relevant to one or more assets represented in the network replica.

In some embodiments, the network replication system 110 employs ETL (Extract, Transform, Load) techniques to obtain and/or otherwise receive data from multiple OT environment data sources. Extraction may include pulling data from one or more OT network environment components as described herein. Transformation may include standardizing, cleansing, filtering, aggregating, normalizing, formatting, and/or otherwise processing the data. Loading may include storing the transformed data in a location accessible by the network replication system 110. In some embodiments, the OT environment data is stored in an OT environment data store 148. As used herein, the term “data store” refers to any repository or collection of data, which may include databases, data warehouses, data lakes, or any other storage system designed to store, manage, and retrieve data. A data store may include structured and/or unstructured data and can be implemented using various technologies such as relational databases, NoSQL databases, graph databases, file systems, cloud storage services, and/or other data storage solutions. A data store may include any physical and/or virtual device, or combination of devices, capable of storing, accessing, and retrieving data, which may include any combination and number of data servers, databases, data storage devices and data storage media, in any physical, virtualized, distributed, and/or clustered environment.

### Example Network Replica

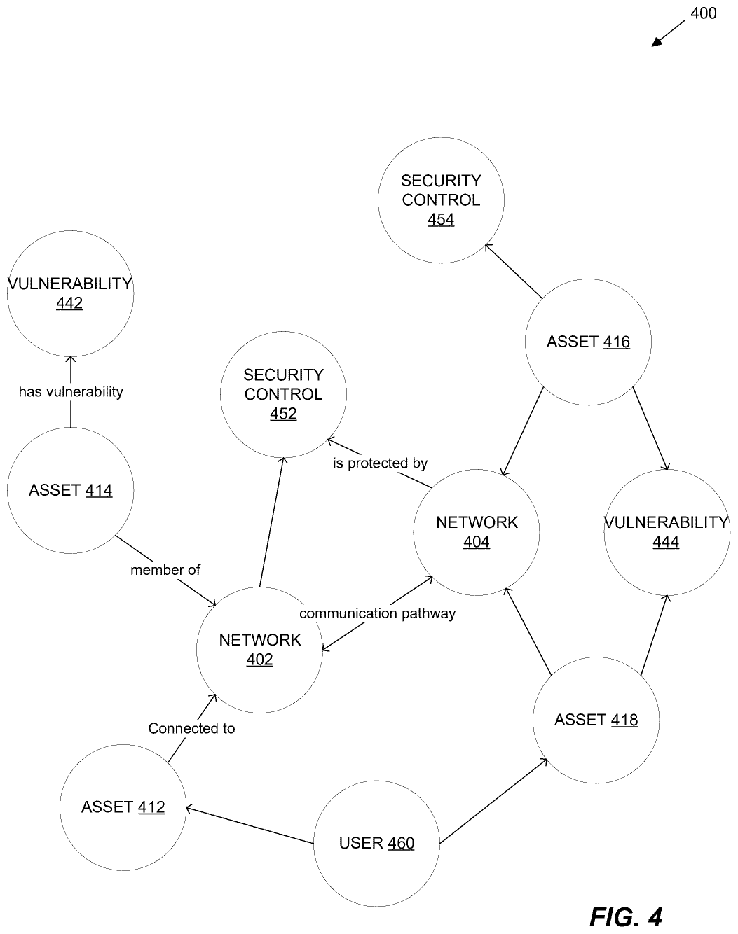

In some embodiments, the network replica comprises a graph database. For example, the network replica may comprise a graph database that includes the structured representation of substantially all assets belonging to the OT network environment. FIG. 4 illustrates a portion of a graph database of a network replica to depict a schema in accordance with one or more embodiments. The graph database 400 may include one or more network nodes 402-404. The network nodes 402-404 correspond to network devices, such as routers, switches, firewalls, and other network appliances that form the network's infrastructure within an OT network environment (e.g., OT network environment 104). Alternatively and/or additionally, the graph database 400 may include one or more asset nodes 412-418 corresponding to assets belonging to the OT network environment. Alternatively and/or additionally, the graph database 400 may include one or more security control nodes 452-454 corresponding to security controls in the OT network environment. Alternatively and/or additionally, the graph database 400 may include one or more vulnerability nodes 442-444 corresponding to vulnerabilities. Alternatively and/or additionally, the graph database 400 may include one or more user nodes 460 corresponding to user accounts. Alternatively and/or additionally, the graph database 400 may include one or more other node types.

A node may be annotated with attributes corresponding to the properties of a particular node. For example, a network node 402-404 may be associated with properties of corresponding networking equipment, such as identifier information, device type, IP address or subnet information, MAC address, manufacturer, model, and firmware version, and/or other properties of the corresponding network equipment. Alternatively and/or additionally, an asset node 412-418 may be associated with properties of a corresponding asset, such as identifier information, asset type, operating system, firmware information, user information, configuration settings, and/or other properties of the corresponding asset. Alternatively and/or additionally, a security control node 452-454 may be associated with properties of the corresponding security control, such as identifier information, control type (e.g., firewall, intrusion detection system, antivirus, access control), deployment status, version, rule set details, configuration information, update status, and/or other properties of the corresponding security control. Alternatively and/or additionally, a vulnerability node 442-444 may be associated with properties of the corresponding vulnerability, such as identifier information, description, affected components, severity rating, exploitability metrics, attack vectors, and/or other properties of the corresponding vulnerability. Alternatively and/or additionally, a user node 460 may be associated with properties of a user, such as identifier information, name, organizational unit, security groups and/or roles, access rights and privileges, authentication information, account status, and/or other properties of the corresponding user.

The graph database 400 includes one or more edges illustrating a relationship between connected nodes, such as communication pathways, control hierarchies, membership, and the like. The edges may be directional, undirected, and/or bidirectional. In some embodiments, an between network nodes 402-404 indicate that a communication pathway exists between network equipment represented by the connected network nodes 402-404.

Alternatively and/or additionally, one or more edges from an asset node 412-418 to a network node 402-404 may indicate that the corresponding asset is connected to the corresponding network equipment. The edges illustrate that: an asset represented by asset node 412 is connected to network equipment represented by network node 402; an asset represented by asset node 414 is connected to network equipment represented by network node 402; an asset represented by asset node 416 is connected to network equipment represented by network node 404; and an asset represented by asset node 418 is connected to network equipment represented by network node 404.

Alternatively and/or additionally, one or more edges from an asset node 412-418 to a vulnerability node 442-444 indicate that the corresponding asset has the corresponding vulnerability. The edges illustrate that: an asset represented by asset node 414 has a vulnerability represented by vulnerability node 442; an asset represented by asset node 416 has a vulnerability represented by vulnerability node 444; an asset represented by asset node 418 has a vulnerability represented by vulnerability node 444.

Alternatively and/or additionally, one or more edges from a network node 402-404 and/or an asset node 412-418 to a security control node 452-454 indicate that a security control represented by the security control node 452-454 protects the network equipment represented by the network node 402-404 and/or the asset represented by the asset node 412-418. The edges illustrate that: network equipment represented by network node 402 is protected by the security control represented by security control node 452; network equipment represented by network node 404 is protected by the security control represented by security control node 452; and an asset represented by asset node 416 is protected by the security control represented by security control node 454.

Alternatively and/or additionally, one or more edges from a user node 460 to an asset node 412-418 indicate that a user has access privileges to a corresponding asset. The edges illustrate that: a user represented by user node 460 has access privileges to an asset represented by asset node 412; and a user represented by user node 460 has access privileges to an asset represented by asset node 418. A user may be a human and/or a programmatic entity.

Alternatively and/or additionally, one or more edges may represent other relationships. One or more relationships and/or properties may be hierarchical and/or inheritable. For example, assets connected to network equipment represented by network node 402 and network node 404 may also be protected by the security control 452.

### Threat Processing System

In some embodiments, the threat analysis system 102 includes a threat processing system 136. The threat processing system is configured to gather threat data describing a plurality of threats capable of compromising an OT network environment 104. The plurality of threats may include traditional IT network threats, OT-specific network threats, and/or a combination thereof. A threat may include any potential event, action, object, and/or condition that could compromise the security, integrity, availability, or functionality of a system, network, or data in a network environment. A threat may be malicious or non-malicious. Threats may include cyberattacks (e.g., malware, phishing, exploits), software vulnerabilities, insider risks, operational failures, and/or other threats. In some embodiments, the plurality of threats includes Techniques, Tactics, and Procedures (TTPs), as described in the MITRE ATT&CK framework, which maps known adversary behaviors to help organizations detect, respond to, and defend against cyber threats. TTPs include known ways a threat can identify, discover, extract, exploit, or disrupt a device or network.

In some embodiments, the threat analysis system 102 obtains and/or otherwise receives threat data from one or more threat data sources 106. The threat data sources 106 may include public and/or private data sources. For example, the threat data sources 106 may include the Cybersecurity & Infrastructure Security Agency (CISA), which publishes vulnerabilities and adversary information for the public. Alternatively and/or additionally, threat data may be received from one or more private threat data sources 106. Alternatively and/or additionally, the threat data sources may include OT-specific threat intelligence data sources that focus on industrial control systems (ICS) and critical infrastructure threats. Alternatively and/or additionally, threat data may be received over one or more threat intelligence data feeds.

In some embodiments, the threat processing system 136 employs ETL (Extract, Transform, Load) techniques to obtain and/or otherwise receive data from one or more threat data sources 106. In some embodiments, the threat processing system 136 normalizes and/or formats threat data to conform to a data model that other components of the threat analysis system 102 can consume. For example, the threat data store 146 may comprise a plurality of threats in a format based on an input format for the attack simulation model 122. In some embodiments, the data model includes a threat name, a description, an attack kill chain phase, and how the threat is used.

In some embodiments, the threat processing system 136 maintains a threat data store 146. In some embodiments, the threat data store 146 comprises a threat database describing a plurality of threats. As used herein, the term “maintain” refers to performing operations on one or more sets of data stored in a database or other data store, such as, but not limited to accessing the data store, adding data to the data store, removing data from the data store, modifying data in the data store, searching the data store, retrieving data from the data store, logging events related to data stored in the data store, communicating with clients to provide access to the data store, and/or other operations related to the data store.

### Attack Simulation System

In some embodiments, the threat analysis system 102 includes an attack simulation system 112. The attack simulation system 112 is configured to simulate attacks by a plurality of threats on the network replica. In some embodiments, the attack simulation system 112 simulates attacks by substantially all of the threats stored in the threat data store 146. Alternatively and/or additionally, the plurality of threats may be a subset of the threats stored in the threat data store 146. The attack simulation system 112 may generate simulated attack data describing a set of simulated attack paths corresponding to one or more threats.

In some embodiments an entity that owns and/or operates the OT network environment 104 may identify one or more assets and/or other components of the OT network environment 104 that are most critical and/or otherwise sensitive. The attack simulation system 112 may be configured to focus on such components as targets of a simulated attack. For example, when the network replica comprises a graph database, a set of target nodes may be identified as targets for simulated attacks.

In some embodiments, the attack simulation system 112 simulates attacks by the plurality of threats by applying an attack simulation model 122 to the network replica and threat data describing the plurality of threats. For example, the inputs to the attack simulation model 122 may include the network replica and the plurality of threats. The output of the attack simulation model 122 may include the set of simulated attack paths. Alternatively and/or additionally, the output of the attack simulation model 122 may include a likelihood of success for each threat and/or simulated attack path included in the simulated attack data.

In some embodiments, the attack simulation model 122 is configured to accept a graph-based network replica, such as a network replica in the form of a graph database. In some embodiments, the attack simulation model 122 is configured to simulate a plurality of attack paths through the graph database simultaneously. The attack simulation model 122 may be configured to attempt to attack the network replica using the plurality of threats over multiple communication paths to reach and/or compromise a set of target nodes. The attack simulation model 122 may be configured to factor in vulnerabilities and/or security controls in the network replica when determining a likelihood of success of a simulated attack path. If the attack simulation model 122 cannot identify a successful way to attack the target nodes using the individual threats, the attack simulation model 122 may simulate combinations of threats over the possible communication paths. In some embodiments, the attack simulation model 122 may be a machine learning model that is configured to process the network replica in a manner that is equivalent to simulating nearly one trillion unique attack paths through the network replica.

In some embodiments, the attack simulation model 122 is generated using machine learning techniques, probabilistic techniques, and/or additional analytical techniques. For example, the attack simulation model 122 may include a neural network, wherein at least a portion of the neural network includes a linear regression model. For example, the neural network may include the linear regression model, followed by a plurality of layers of the neural network.

Alternatively and/or additionally, the attack simulation model 122 may include a reinforcement learning model comprising a representation network configured to encode the current state of the network replica into a latent space representation, a dynamics network configured to predict a future state in an attack sequence given a simulated action, a prediction network configured to estimate the likelihood of success for simulated attack paths; and a value function that optimizes attack path selection.

Alternatively and/or additionally, the attack simulation model 122 may be configured to utilize a Monte Carlo Tree Search (MCTS) decision process. Monte Carlo simulation introduces random sampling to model uncertainty, enabling the simulation of multiple scenarios by drawing random values from probability distributions. For example, graph algorithms may be used to determine the shortest path through a graph-based network replica to a target node. The data from each node and edge may be placed into combinations and permutations to form the decision tree. With each new decision, the tree opens up different possibilities within the attack path. Each previous step affects future steps within the decision tree and a categorical regression ML model may be used to determine the likelihood success of a particular simulated attack by a particular threat, taking into account the connections and relationships within the network replica.

In some embodiments, the attack simulation model 122 is trained using unsupervised methods that utilize a corpus of public datasets to build reasoning and knowledge within the neural networks. The public datasets range from understanding JSON structure to encyclopedia and book data. Alternatively and/or additionally, the AI model may be fine-tuned using supervised methods.

### Attack Analysis System

In some embodiments, the threat analysis system 102 includes an attack analysis system 114. The attack analysis system 114 is configured to provide one or more risk reduction recommendations based on the simulated attack data generated by applying the attack simulation model 122 to the network replica. For example, when the simulated attack data includes simulated attack paths for a set of one or more threats, the attack analysis system 114 may determine one or more appropriate security controls that can prevent and/or mitigate the corresponding threat, reducing the risk of the threat to the OT network environment 104.

The attack analysis system 114 may generate the risk reduction recommendations based on any computing techniques, and may utilize deterministic techniques and/or rule-based techniques. Alternatively and/or additionally, the attack analysis system 114 may utilize one or more machine learning techniques to generate the risk reduction recommendations. In some embodiments, the attack analysis system 114 is configured to generate the risk reduction recommendations by applying an attack analysis language model 124 to the simulated attack data. The attack analysis language model 124 is configured to analyze the input attack data and output human-readable text. For example, the attack analysis language model 124 may be configured to reason about attack data, such as an attack path and its likelihood of success, based on probabilistic pattern recognition encoded in the attack analysis language model 124. For example, the attack analysis language model 124 may make causal inferences to explain an attack path and/or to generate a risk reduction recommendation.

The attack analysis language model 124 may comprise any language model, such as such as a Transformer-based model, a state space model (SSM), and/or other language models. In some embodiments, the attack analysis language model 124 is based on a retentive network. In contrast to transformer-based large language models, a retentive network is optimized for handling long sequences while managing computational complexity. In some embodiments, the attack analysis language model 124 is quantized to reduce the model size and improve the speed of inference, allowing for execution on standard computing devices. Alternatively and/or additionally, the attack analysis language model 124 may use a Mixture of Experts (MoE) approach, where specialized sub-models handle different tasks, potentially reducing computational load and allowing the attack analysis language model 124 to develop domain-specific expertise. Alternatively and/or additionally, the attack analysis language model 124 uses multi-turn prompt ingestion techniques to prevent the lost-in-the-middle context problem with language models. For example, a large attack path may be provided to the attack analysis language model 124 in multiple prompts, enforcing the analysis of the attack path as a whole. Alternatively and/or additionally, the attack analysis language model 124 may use Retrieval Augmented Generation (RAG) techniques to add additional information about the threat, the attack path, and/or the risk reduction recommendations.

In some embodiments, the attack analysis language model 124 is trained based on one or more open-source data sets such as books, articles, websites, manuals, publications, standards, public threat intelligence feeds, and/or other open-source text. Alternatively and/or additionally, the attack analysis language model 124 may be trained based on one or more closed-source data sets such as security assessment reports, private threat intelligence feeds, and/or other closed-source text.

In some embodiments, the attack analysis system 114 is configured to remove personally identifiable information (PII) and/or other sensitive information. For example, the attack analysis system 114 may be configured to remove sensitive information before applying the attack analysis language model 124. Alternatively and/or additionally, the attack analysis system 114 may be configured to remove sensitive information from the output of the attack analysis language model 124.

### Model Generation System

In some embodiments, the threat analysis system 102 includes a model generation system 130. The model generation system 130 may be configured to train and/or otherwise generate the attack simulation model 122. Alternatively and/or additionally, the model generation system 130 may be configured to train and/or otherwise generate the attack analysis language model 124. The model generation system 130 may train the attack simulation model 122 and/or the attack analysis language model 124, test the attack simulation model 122 and/or the attack analysis language model 124, update the attack simulation model 122 and/or the attack analysis language model 124 and/or otherwise maintain the attack simulation model 122 and/or the attack analysis language model 124. In some embodiments, the threat analysis system 102 receives and/or analyzes newly available threat intelligence, attack patterns, publications, other data sets, and/or performance assessments of the threat analysis system 102 on production OT network environments 104, which may be used to train and/or update the attack simulation model 122 and/or the attack analysis language model 124.

### Example Data Flow

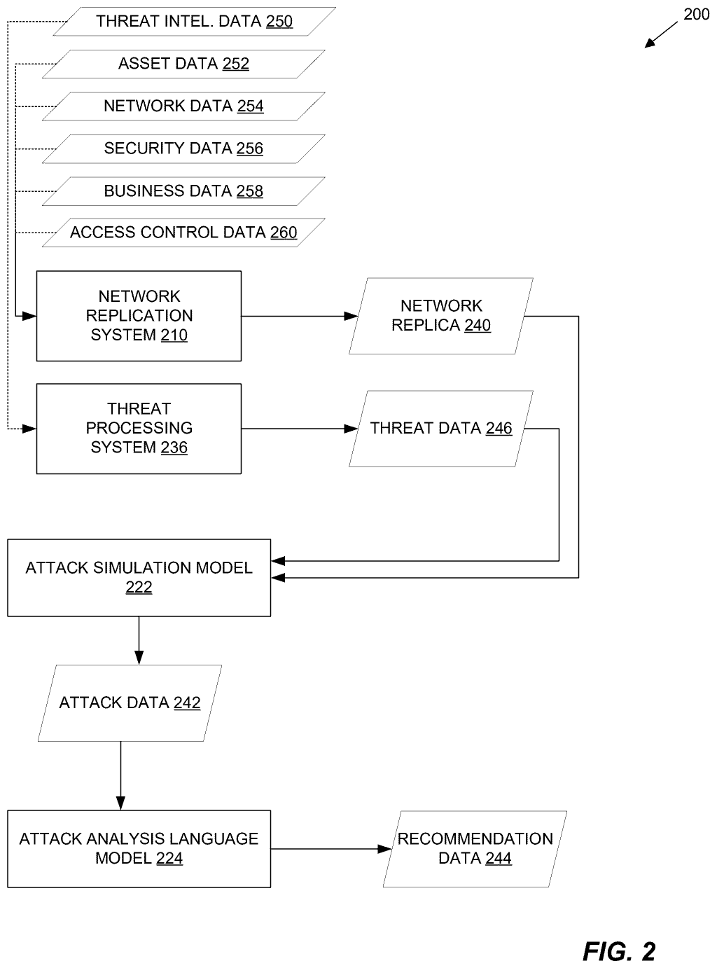

FIG. 2 illustrates data flow between components of a threat analysis system in accordance with one or more embodiments. In a threat analysis system 200, a network replication system 210 receives OT environment data, such as asset data 252, network data 254, security data 256, business data 258, access control data 260 and/or other OT environment data from one or more OT environment data sources. The network replication system 210 outputs a network replica 240. The network replica 240 is a representation of an OT network environment (e.g., OT network environment 104), which may be a production OT network environment.

A threat processing system 236 receives threat intelligence data 250 and outputs threat data 246 describing a plurality of threats capable of compromising an OT network environment 104.

The inputs of the attack simulation model 222 may include the network replica 240 and the threat data 246. The attack simulation model 222 outputs attack data 242. The attack data 242 may include a set of simulated attack paths corresponding to one or more threats. Alternatively and/or additionally, the attack data 242 may include a likelihood of success for one or more simulated attack paths.

The inputs of the attack analysis language model 224 include the attack data 242. The attack analysis language model 224 outputs recommendation data 244 comprising one or more risk reduction recommendations. The risk reduction recommendation/s may include one or more security controls that can prevent and/or mitigate a threat corresponding to a simulated attack path of the attack data 242.

In some embodiments, the network replication system 210 may generate an updated network replica 240 based on one or more changes to the OT network environment. The change/s may be detected based on the OT environment data (e.g., asset data 252, network data 254, security data 256, business data 258, access control data 260 and/or other OT environment data). Alternatively and/or additionally, the threat processing system 236 may generate updated threat data 246 based on one or more changes to the threat data, which may be detected based on the threat intelligence data 250. The attack simulation model 222 may be applied to the updated network replica 240 and/or the updated threat data 246 to generate updated attack data 242. The attack analysis language model 224 may be applied to the updated attack data 242 to generate updated recommendation data 244 comprising one or more additional risk reduction recommendations.

### Example Network Arrangement

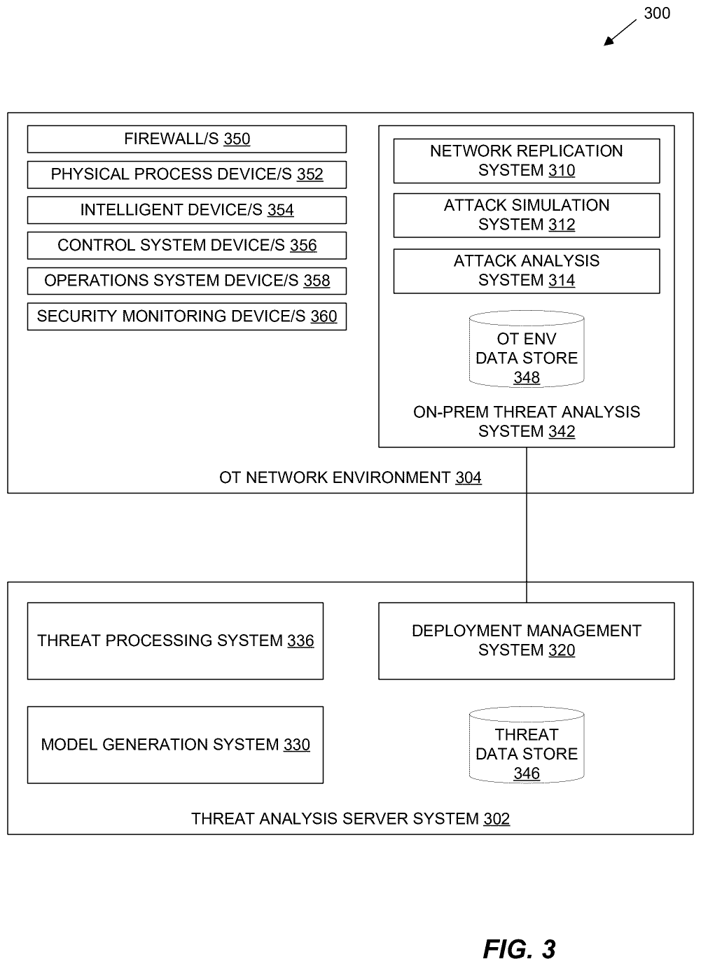

FIG. 3 illustrates a computer system that includes an on-premises threat analysis system in an OT network in accordance with one or more embodiments. The computer system 300 includes a threat analysis server system 302 and an OT network environment 304. The OT network environment 304 includes an on-premises threat analysis system 342.

In some embodiments, the on-premises threat analysis system 342 is generated for deployment in an entity's OT network environment 304. The on-premises threat analysis system 342 is configured to generate a network replica, simulate attacks by applying an attack simulation model to the input network replica, and provide one or more risk reduction recommendations based on simulated attack data generated by the attack simulation model. In some embodiments, the on-premises threat analysis system 342 is configured to apply an attack analysis language model to the simulated attack data to generate the risk reduction recommendation/s. The on-premises threat analysis system 342 may be deployed by providing computer-readable instructions for execution on one or more computing devices in an OT network environment 342.

In some embodiments, the on-premises threat analysis system 342 is configured to maintain sensitive information within the OT network environment 304. The OT environment data of an entity's OT network environment 304 may include personally identifiable information (PII) and/or other sensitive information with respect to the entity, an individual associated with the entity, the entity OT network, and/or devices in the entity OT network.

In some embodiments, the on-premises threat analysis system 340 includes a network replication system 310. The network replication system 310 may be configured to operate on-premises, or within the OT network environment 304, to generate a network replica corresponding to the OT network environment 304 without requiring any data to be exported from the OT network environment 304. For example, the network replication system 310 may obtain and/or otherwise receive network data and/or asset data related to one or more firewalls 350, physical process devices 352, intelligent devices 354, control system devices 356, operations system devices 358, and/or security monitoring devices 360. The network replication system 310 may maintain an OT environment data store 248 within the OT network environment 304.

Alternatively and/or additionally, the on-premises threat analysis system 340 may include an attack simulation system 312. The attack simulation system 312 may be configured to operate on premises, or within the OT network environment 304, such that the attack simulation system 312 simulates attacks on the network replica without exporting the network replica from the OT network environment 304. The attack simulation system 312 may generate simulated attack data.

Alternatively and/or additionally, the on-premises threat analysis system 340 may include an attack analysis system 314. The attack analysis system 314 may be configured to operate on premises, or within the OT network environment 304, such that the attack analysis system 314 generates risk reduction recommendations for the OT network environment 304 based on the simulated attack data generated by the attack simulation system 312. The attack analysis system 314 may process the simulated attack data without exporting the simulated attack data from the OT network environment 304.

The threat analysis server system 302 is configured to support one or more on-premises threat analysis systems 342 deployed in one or more OT network environments 304. The threat analysis server system 302 may support such on-premises threat analysis system 342 for one or multiple entities. In some embodiments, the threat analysis server system 302 is deployed in a public cloud. Alternatively and/or additionally, the threat analysis server system 302 may be deployed in a computer server system connected to the Internet.

In some embodiments, the threat analysis server system 302 includes a threat processing system 336. The threat processing system 336 may be configured to gather threat data describing a plurality of threats capable of compromising an OT network environment 304. The threat processing system 336 may maintain a threat data store 346 comprising the threat data.

Alternatively and/or additionally, the threat analysis server system 302 may include a model generation system 330. In some embodiments, the model generation system 330 trains and/or otherwise generates an attack simulation model (e.g., attack simulation model 122). Alternatively and/or additionally, the model generation system 330 may train and/or otherwise generate an attack analysis language model (e.g., attack analysis language model 124).

Alternatively and/or additionally, the threat analysis server system 302 may include a deployment management system 320. The deployment management system 320 is configured to support one or more instances of the on-premises threat analysis system 342. For example, the deployment management system 320 may be configured to provide threat data from the threat data store 346 to the on-premises threat analysis system 342. Alternatively and/or additionally, the deployment management system 320 may be configured to provide an attack simulation model generated by the model generation system 330 to the on-premises threat analysis system 342, which may be used by the attack simulation system 312. Alternatively and/or additionally, the deployment management system 320 may be configured to provide an attack analysis language model generated by the model generation system 330 to the on-premises threat analysis system 342, which may be used by the attack analysis system 314.

In some embodiments, the on-premises threat analysis system 342 is deployed in an isolated network. The deployment management system 320 may be configured to prepare software updates for an isolated on-premises threat analysis system 342 for delivery in accordance with known security techniques. For example, updated configuration data, threat data, attack simulation models, attack analysis language models and/or other updates may be transferred using removable storage devices, air-gapped update servers, one-way transfer devices, cryptographic techniques, access control policies, and/or other techniques.

### Example Processes

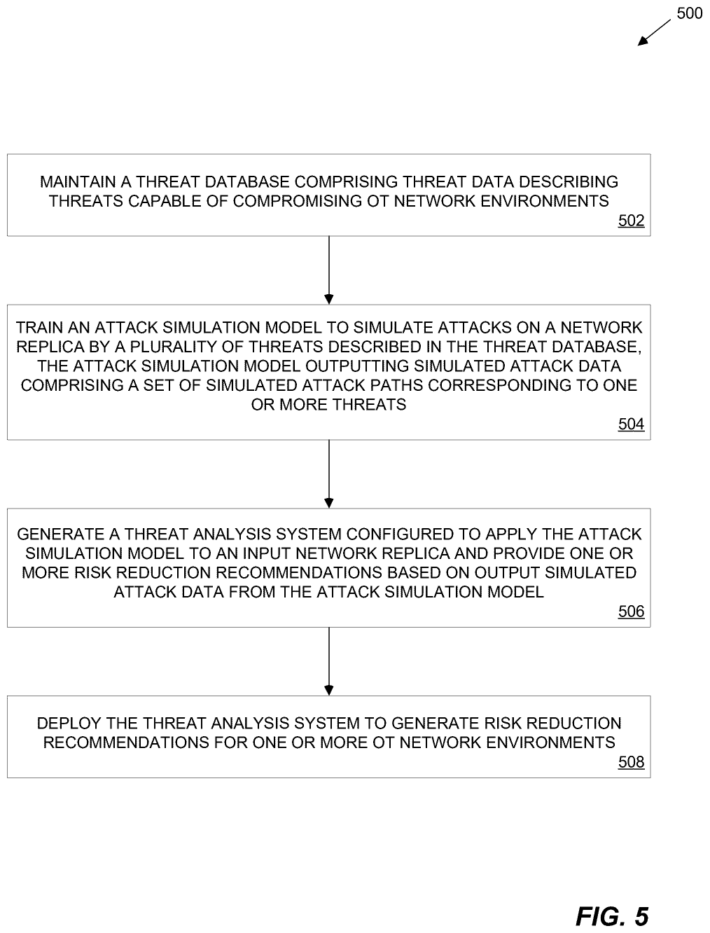

FIG. 5 is a flow diagram of a process for training and using an attack simulation model in an example embodiment. Process 500 may be performed by one or more computing devices and/or processes thereof. For example, one or more blocks of process 500 may be performed by computer system 600. In some embodiments, one or more blocks of process 500 are performed by a threat analysis server system executing on one or more hardware and/or virtual computers, such as the threat analysis server system 302 of FIG. 3. Process 500 will be described with respect to the threat analysis system 102 of FIG. 1, but its performance is not limited thereto.

At block 502, the threat analysis system 102 maintains a threat database comprising threat data describing threats capable of compromising operational technology (OT) network environments.

At block 504, the threat analysis system 102 trains an attack simulation model to simulate attacks on a network replica by a plurality of threats described in the threat database. The attack simulation model outputs simulated attack data comprising a set of simulated attack paths corresponding to one or more threats of the plurality of threats. The network replica comprises a structured representation of a plurality of assets belonging to an OT network environment, communication pathways between the plurality of assets, security controls implemented in the OT network environment, and vulnerabilities.

At block 506, the threat analysis system 102 generates a threat analysis system configured to apply the attack simulation model to an input network replica and provide one or more risk reduction recommendations based on output simulated attack data from the attack simulation model.

At block 508, the threat analysis system 102 deploys the threat analysis system to generate risk reduction recommendations for one or more OT network environments.

### Implementation Mechanisms—Hardware Overview

According to one embodiment, the techniques described herein are implemented by one or more special-purpose computing devices. The special-purpose computing devices may be hard-wired to perform one or more techniques described herein, including combinations thereof. Alternatively and/or in addition, the one or more special-purpose computing devices may include digital electronic devices such as one or more application-specific integrated circuits (ASICs) or field-programmable gate arrays (FPGAs) that are persistently programmed to perform the techniques. Alternatively and/or in addition, the one or more special-purpose computing devices may include one or more general-purpose hardware processors programmed to perform the techniques described herein pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, and/or any other device that incorporates hard-wired or program logic to implement the techniques.

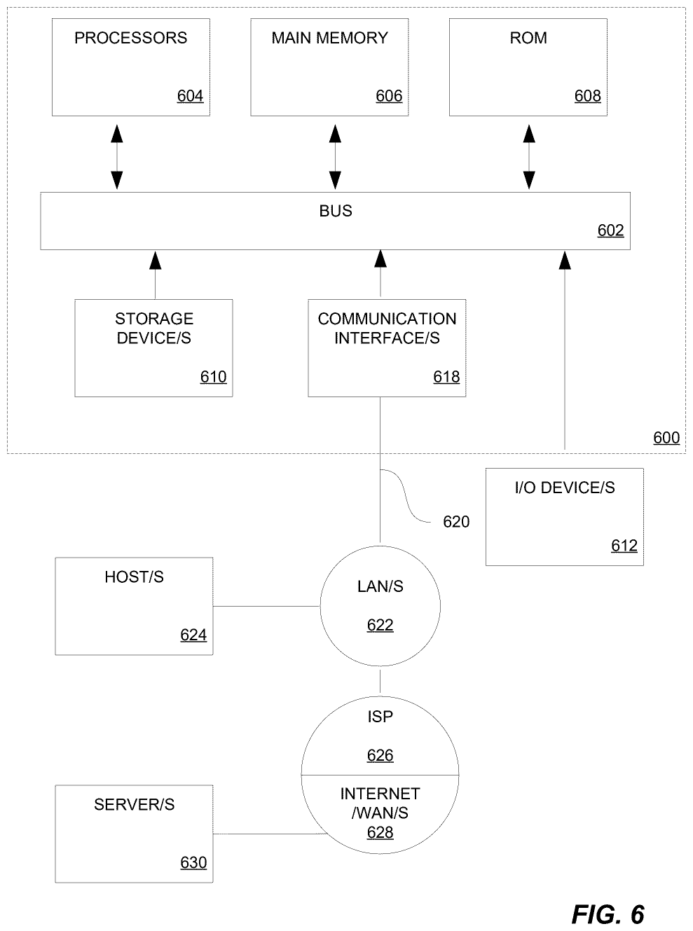

FIG. 6 is a block diagram that illustrates a computer system 600 upon which one or more embodiments described herein may be implemented. The computer system 600 includes a bus 602 or another communication mechanism for communicating information, and one or more hardware processors 604 coupled with bus 602 for processing information, such as computer instructions and data. The hardware processor/s 604 may include one or more general-purpose microprocessors, graphical processing units (GPUs), coprocessors, central processing units (CPUs), and/or other hardware processing units. As an alternative or addition, one or more computer systems 600 may be configured to provide a cloud computing environment, virtual machine, and/or other software-based emulation of a physical computing environment upon which one or more embodiments described herein may be implemented.

The computer system 600 also includes one or more units of main memory 606 coupled to the bus 602, such as random-access memory (RAM) or other dynamic storage, for storing information and instructions to be executed by the processor/s 604. Main memory 606 may also be used for storing temporary variables or other intermediate information during execution of instructions to be executed by the processor/s 604. Such instructions, when stored in non-transitory storage media accessible to the processor/s 604, turn the computer system 600 into a special-purpose machine that is customized to perform the operations specified in the instructions. In some embodiments, main memory 606 may include dynamic random-access memory (DRAM) (such as double data rate synchronous dynamic random-access memory (DDR SDRAM), thyristor random-access memory (T-RAM), zero-capacitor (Z-RAM™)) and/or non-volatile random-access memory (NVRAM).

The computer system 600 may further include one or more units of read-only memory (ROM) 608 or other static storage coupled to the bus 602 for storing information and instructions for the processor/s 604 that are either always static or static in normal operation but reprogrammable. For example, the ROM 608 may store firmware for the computer system 600. The ROM 608 may include mask ROM (MROM) or other hard-wired ROM storing purely static information, programmable read-only memory (PROM), erasable programmable read-only memory (EPROM), electrically-erasable programmable read-only memory (EEPROM), another hardware memory chip or cartridge, or any other read-only memory unit.

One or more storage devices 610, such as a magnetic disk or optical disk, is provided and coupled to the bus 602 for storing information and/or instructions. The storage device/s 610 may include non-volatile storage media such as, for example, read-only memory, optical disks (such as compact discs (CDs), digital video discs (DVDs), Blu-ray discs (BDs)), magnetic disks, other magnetic media such as floppy disks and magnetic tape, solid-state drives, flash memory, optical disks, one or more forms of non-volatile random-access memory (NVRAM), and/or other non-volatile storage media.

The computer system 600 may be coupled via the bus 602 to one or more input/output (I/O) devices 612. For example, the I/O device/s 612 may include one or more displays for displaying information to a computer user, such as a cathode ray tube (CRT) display, a Liquid Crystal Display (LCD) display, a Light-Emitting Diode (LED) display, a projector, and/or any other type of display.

The I/O device/s 612 may also include one or more input devices, such as an alphanumeric keyboard and/or any other keypad device. The one or more input devices may also include one or more cursor control devices, such as a mouse, a trackball, a touch input device, or cursor direction keys for communicating direction information and command selections to the processor 604 and for controlling cursor movement on another I/O device (e.g. a display). A cursor control device typically has at degrees of freedom in two or more axes, (e.g. a first axis x, a second axis y, and optionally one or more additional axes z), that allows the device to specify positions in a plane. In some embodiments, the one or more I/O device/s 612 may include a device with combined I/O functionality, such as a touch-enabled display.

Other I/O device/s 612 may include a fingerprint reader, a scanner, an infrared (IR) device, an imaging device such as a camera or video recording device, a microphone, a speaker, an ambient light sensor, a pressure sensor, an accelerometer, a gyroscope, a magnetometer, another motion sensor, or any other device that can communicate signals, commands, and/or other information with the processor/s 604 over the bus 602.

The computer system 600 may implement the techniques described herein using customized hard-wired logic, one or more ASICs or FPGAs, firmware, and/or program logic that causes computer system 600 to be a special-purpose machine. According to one embodiment, the techniques herein are performed by the computer system 600 in response to the processor/s 604 executing one or more sequences of one or more instructions contained in main memory 606. Such instructions may be read into main memory 606 from another storage medium, such as the one or more storage device/s 610. Execution of the sequences of instructions contained in main memory 606 causes the processor/s 604 to perform the process steps described herein. In alternative embodiments, hard-wired circuitry may be used in place of or in combination with software instructions.

The computer system 600 also includes one or more communication interfaces 618 coupled to the bus 602. The communication interface/s 618 provide two-way data communication over one or more physical or wireless network links 620 that are connected to a local network 622 and/or a wide area network (WAN), such as the Internet. For example, the communication interface/s 618 may include an integrated services digital network (ISDN) card, cable modem, satellite modem, or a modem to provide a data communication connection to a corresponding type of telephone line. Alternatively and/or in addition, the communication interface/s 618 may include one or more of: a local area network (LAN) device that provides a data communication connection to a compatible local network 622; a wireless local area network (WLAN) device that sends and receives wireless signals (such as electrical signals, electromagnetic signals, optical signals or other wireless signals representing various types of information) to a compatible LAN; a wireless wide area network (WWAN) device that sends and receives such signals over a cellular network; and other networking devices that establish a communication channel between the computer system 600 and one or more LANs 622 and/or WANs.

The network link/s 620 typically provides data communication through one or more networks to other data devices. For example, the network link/s 620 may provide a connection through one or more local area networks 622 (LANs) to one or more host computers 624 or to data equipment operated by an Internet Service Provider (ISP) 626. The ISP 626 provides connectivity to one or more wide area networks 628, such as the Internet. The LAN/s 622 and WAN/s 628 use electrical, electromagnetic, or optical signals that carry digital data streams. The signals through the various networks and the signals on the network link/s 620 and through the communication interface/s 618 are example forms of transmission media or transitory media.

The term “storage media” as used herein refers to any non-transitory media that stores data and/or instructions that cause a machine to operate in a specific fashion. Such storage media may include volatile and/or non-volatile media. Storage media is distinct from but may be used in conjunction with transmission media. Transmission media participates in transferring information between storage media. For example, transmission media includes coaxial cables, copper wire, and fiber optics, including traces and/or other physical electrically conductive components that comprise the bus 602. Transmission media can also take the form of acoustic or light waves, such as those generated during radio-wave and infrared data communications.

Various forms of media may be involved in carrying one or more sequences of one or more instructions to the processor 604 for execution. For example, the instructions may initially be carried on a magnetic disk or solid-state drive of a remote computer. The remote computer can load the instructions into its main memory 606 and send the instructions over a telecommunications line using a modem. A modem local to the computer system 600 can receive the data on the telephone line and use an infrared transmitter to convert the data to an infrared signal. An infra-red detector can receive the data carried in the infra-red signal and appropriate circuitry can place the data on the bus 602. The bus 602 carries the data to main memory 606, from which the processor 604 retrieves and executes the instructions. The instructions received by main memory 606 may optionally be stored on the storage device 610 either before or after execution by the processor 604.

The computer system 600 can send messages and receive data, including program code, through the network(s), the network link 620, and the communication interface/s 618. In the Internet example, one or more servers 630 may transmit signals corresponding to data or instructions requested for an application program executed by the computer system 600 through the Internet 628, ISP 626, local network 622 and a communication interface 618. The received signals may include instructions and/or information for execution and/or processing by the processor/s 604. The processor/s 604 may execute and/or process the instructions and/or information upon receiving the signals by accessing main memory 606, or at a later time by storing them and then accessing them from the storage device/s 610.

### Other Aspects of Disclosure

One aspect of the disclosure is directed to a method comprising: receiving operational technology (OT) environment data describing a plurality of assets belonging to an OT network environment comprising one or more OT networks, the OT environment data comprising network data and asset data; generating a network replica of the OT network environment based on the network data and the asset data, the network replica comprising a structured representation of the plurality of assets, communication pathways between the plurality of assets, security controls implemented in the OT network environment, and vulnerabilities; applying an attack simulation model to the network replica and threat data describing a plurality of threats capable of compromising OT network environments, the attack simulation model configured to simulate attacks by the plurality of threats on the network replica and generate simulated attack data describing a set of simulated attack paths corresponding to one or more threats; and providing one or more risk reduction recommendations based on the simulated attack data; wherein the method is performed by one or more processors.

In some examples, the OT network environment is a production OT network environment; and the OT environment data is received from the production OT network environment.

In some examples, the OT environment data received includes business data; and generating the network replica is based on the business data.

In some examples, the OT environment data received includes security data generated by one or more OT security vendors; and generating the network replica is based on the security data.

In some examples, the method comprises maintaining a threat database comprising the plurality of threats based on threat intelligence data received from one or more threat intelligence data sources.

In some examples, the network replica comprises a graph database that includes the structured representation of substantially all assets belonging to the OT network environment.

In some examples, the method is performed on one or more computing devices located within the OT network environment.

In some examples, the method comprises generating an updated network replica based on one or more changes to the OT network environment; applying the attack simulation model to the updated network replica and the threat data to generate updated simulated attack data; and providing one or more additional risk reduction recommendations based on the updated simulated attack data. Alternatively and/or additionally, generating the updated network replica is performed in response to detecting the one or more changes to the OT network environment based on the OT environment data received.

In some examples, the method comprises generating updated threat data based on one or more changes to the threat data; applying the attack simulation model to the network replica and the updated threat data to generate updated simulated attack data; and providing one or more additional risk reduction recommendations based on the updated simulated attack data.

In some examples, the method comprises generating the one or more risk reduction recommendations by applying an attack analysis language model to the simulated attack data.

One aspect of the disclosure is directed to a non-transitory computer-readable medium storing instructions that, when executed by one or more processors of a computer system, cause the computer system to: receive operational technology (OT) environment data describing a plurality of assets belonging to an OT network environment comprising one or more OT networks, the OT environment data comprising network data and asset data; generate a network replica of the OT network environment based on the network data and the asset data, the network replica comprising a structured representation of the plurality of assets, communication pathways between the plurality of assets, security controls implemented in the OT network environment, and vulnerabilities; apply an attack simulation model to the network replica and threat data describing a plurality of threats capable of compromising OT network environments, the attack simulation model configured to simulate attacks by the plurality of threats on the network replica and generate simulated attack data describing a set of simulated attack paths corresponding to one or more threats; and provide one or more risk reduction recommendations based on the simulated attack data.

In some examples, the OT network environment is a production OT network environment; and the OT environment data is received from the production OT network environment.

In some examples, the OT environment data received includes business data; and generating the network replica is based on the business data.

In some examples, the OT environment data received includes security data generated by one or more OT security vendors; and generating the network replica is based on the security data.

In some examples, the instructions, when executed by the one or more processors, cause the computer system to: generate an updated network replica based on one or more changes to the OT network environment; apply the attack simulation model to the updated network replica and the threat data to generate updated simulated attack data; and provide one or more additional risk reduction recommendations based on the updated simulated attack data.

In some examples, generating the updated network replica is performed in response to detecting the one or more changes to the OT network environment based on the OT environment data received.

In some examples, the instructions, when executed by the one or more processors, cause the computer system to: generate updated threat data based on one or more changes to the threat data; apply the attack simulation model to the network replica and the updated threat data to generate updated simulated attack data; and provide one or more additional risk reduction recommendations based on the updated simulated attack data.

In some examples, the instructions, when executed by the one or more processors, cause the computer system to: generate the one or more risk reduction recommendations by applying an attack analysis language model to the simulated attack data.

One aspect of the disclosure is directed to a computer system comprising: one or more hardware processors; at least one memory storing one or more instructions which, when executed by the one or more hardware processors, cause the one or more hardware processors to: receive operational technology (OT) environment data describing a plurality of assets belonging to an OT network environment comprising one or more OT networks, the OT environment data comprising network data and asset data; generate a network replica of the OT network environment based on the network data and the asset data, the network replica comprising a structured representation of the plurality of assets, communication pathways between the plurality of assets, security controls implemented in the OT network environment, and vulnerabilities; apply an attack simulation model to the network replica and a threat database comprising threat data describing a plurality of threats, the attack simulation model configured to simulate attacks by the plurality of threats on the network replica and generate simulated attack data describing a set of simulated attack paths corresponding to one or more threats; and provide one or more risk reduction recommendations based on the simulated attack data.

Although the concepts herein have been described with reference to particular embodiments, it is to be understood that these embodiments are merely illustrative of the principles and applications of the present disclosure. Unless otherwise specified, descriptions of individual elements depicted in one drawing are understood to optionally apply to similar elements depicted in other drawings, either individually or in combination. It is therefore to be understood that numerous modifications may be made to the illustrative embodiments and that other arrangements may be devised without departing from the spirit and scope of the present disclosure, and as defined by the appended claims.

What is claimed is:

1. A method comprising:
maintaining a threat database comprising threat data describing threats capable of compromising operational technology (OT) network environments;
training an attack simulation model to simulate attacks on a network replica by a plurality of threats described in the threat database, the attack simulation model outputting simulated attack data comprising a set of simulated attack paths corresponding to one or more threats of the plurality of threats, the network replica comprising a structured representation of a plurality of assets belonging to an OT network environment, communication pathways between the plurality of assets, security controls implemented in the OT network environment, and vulnerabilities;
generating a threat analysis system configured to apply the attack simulation model to an input network replica and provide one or more risk reduction recommendations based on output simulated attack data from the attack simulation model; and
deploying the threat analysis system to generate risk reduction recommendations for one or more OT network environments;
wherein the method is performed by one or more processors.

2. The method of claim 1, wherein the attack simulation model is a reinforcement learning model comprising:
a representation network configured to encode the current state of the network replica into a latent space representation;
a dynamics network configured to predict a future state in an attack sequence given a simulated action;
a prediction network configured to estimate a likelihood of success for simulated attack paths; and
a value function that optimizes attack path selection.

3. The method of claim 1, wherein the attack simulation model comprises a neural network, wherein at least a portion of the neural network includes a linear regression model.

4. The method of claim 1, wherein the attack simulation model is configured to utilize a Monte Carlo Tree Search (MCTS) decision process.

5. The method of claim 1, wherein the network replica comprises a graph database that includes the structured representation of substantially all connected assets in the OT network environment.

6. The method of claim 5, wherein the attack simulation model is configured to simulate a plurality of attack paths through the graph database simultaneously.

7. The method of claim 1, wherein the threat analysis system is configured to apply an attack analysis language model to the simulated attack data to generate the one or more risk reduction recommendations.

8. The method of claim 7, wherein the attack analysis language model is based on a retentive network.

9. The method of claim 7, further comprising training the attack analysis language model.

10. The method of claim 1, wherein deploying the threat analysis system includes providing computer-readable instructions for execution on one or more computing devices in a customer OT network environment.

11. A computer system comprising:
one or more hardware processors;
at least one memory storing one or more instructions which, when executed by the one or more hardware processors, cause the one or more hardware processors to:
maintain a threat database comprising threat data describing threats capable of compromising OT network environments;
train an attack simulation model to simulate attacks on a network replica by a plurality of threats described in the threat database, the attack simulation model outputting simulated attack data comprising a set of simulated attack paths corresponding to one or more threats of the plurality of threats, the network replica comprising a structured representation of a plurality of assets belonging to an OT network environment, communication pathways between the plurality of assets, security controls implemented in the OT network environment, and vulnerabilities;
generate a threat analysis system configured to apply the attack simulation model to an input network replica and provide one or more risk reduction recommendations based on output simulated attack data from the attack simulation model; and
deploy the threat analysis system to generate risk reduction recommendations for one or more OT network environments.

12. The computer system of claim 11, wherein the attack simulation model is a reinforcement learning model comprising:
a representation network configured to encode the current state of the network replica into a latent space representation;
a dynamics network configured to predict a future state in an attack sequence given a simulated action;
a prediction network configured to estimate a likelihood of success for simulated attack paths; and
a value function that optimizes attack path selection.

13. The computer system of claim 11, wherein the attack simulation model comprises a neural network, wherein at least a portion of the neural network includes a linear regression model.

14. The computer system of claim 11, wherein the attack simulation model is configured to utilize a Monte Carlo Tree Search (MCTS) decision process.

15. The computer system of claim 11, wherein the network replica comprises a graph database that includes the structured representation of substantially all connected assets in the OT network environment.

16. The computer system of claim 15, wherein the attack simulation model is configured to simulate a plurality of attack paths through the graph database simultaneously.

17. The computer system of claim 11, wherein the threat analysis system is configured to apply an attack analysis language model to the simulated attack data to generate the one or more risk reduction recommendations.

18. The computer system of claim 17, wherein the attack analysis language model is based on a retentive network.

19. The computer system of claim 17, further comprising training the attack analysis language model.

20. The computer system of claim 11, wherein deploying the threat analysis system includes providing computer-readable instructions for execution on one or more computing devices in a customer OT network environment.
